(19) United States
(12) Patent Application Publication
(10) Pub. No.: US 2019/0363583 A1
(43) Pub. Date: Nov. 28, 2019

(54) WIRELESS POWER SUPPLY SYSTEM, A POWER RECEIVING DEVICE AND A POWER RECEIVING METHOD FOR A MUSICAL INSTRUMENT

(71) Applicant: Yamaha Corporation, Shizuoka-ken (JP)

(72) Inventors: Satsuki KAWAHASHI, Hamamatsu-shi (JP); Naoyuki ONOZAWA, Hamamatsu-shi (JP); Kenji IWAMOTO, Hamamatsu-shi (JP)

(73) Assignee: Yamaha Corporation

(21) Appl. No.: 15/986,821

(22) Filed: May 23, 2018

(51) Int. Cl. H02J 50/20; H02J 50/40; H02J 7/02; G10D 3/06; G10D 1/08

(52) U.S. Cl. CPC H02J 50/20; H02J 50/40; G10D 1/08; G10D 3/06; H02J 7/025

(57) ABSTRACT

A wireless power supply system to for musical instrument comprises: a power supply device which is configured to wirelessly transmit microwaves, and a first power receiving device which is attached to a first musical instrument. The first power receiving device is configured to: receive the wirelessly transmitted microwave, and generate a first electric power from the received microwave, wherein the first electric power is supplied to at least one of a first electronic device installed in the first musical instrument and a first battery installed in the first musical instrument.

### TECHNICAL FIELD

The present disclosure relates to a power supply system, a power receiving device and a power receiving method for a musical instrument, where wirelessly transmitted microwaves is used for generating electric power.

### BACKGROUND

There are musical instruments which are powered by using a wireless power supply. These musical instruments have rechargeable batteries which receive power through inductive charging or through magnetic resonance.

However, the above methods use non-radiant energy, and thus a range of power transmission is geographically limited. Accordingly, the power transmission from a power transmitter to a power receiver can only occur within a short range (e.g., from a few centimeters to around 10 centimeters). Thus, in the music instruments which use the non-radiant energy as the wireless power supply, the power receivers, which are disposed in the musical instruments, should be placed close to the power transmitter. Accordingly, the musical instruments must be placed close to the power transmitter.

For example, in U.S. Pat. No. 9,685,148, which discloses wirelessly charging a rechargeable battery using the inductive charging, a power transmitter 108 is positioned on an interior surface of a guitar case 107 so that it is sufficiently close to a power receiver (i.e., a second resonator 103) attached to the guitar 101 disposed in the guitar case 107. In addition, an acoustic guitar 300 having a power receiver 301 is positioned on a work pad 303 coupled to a wireless power transmitter 301. The other embodiments also disclose that the wireless power transmitters are located close to the power receivers.

In addition, in U.S. Pat. No. 8,193,768, which discloses wirelessly charging the reachable battery using the magnetic resonance, a first coil housing 14 (i.e., a power transmitter side) and a second coil housing 10 (i.e., a power receiver side) are placed close to each other.

Further, in these disclosures, one power transmitter transmits power to one musical instrument. In addition, the rechargeable batteries are charged only when the guitars are not being played.

Thus, in the musical instruments which receive wirelessly transmitted power using the inductive charging and the magnetic resonance, because the power receiver installed in the musical instrument and the power transmitter should be placed close to each other, the location of the power receiver (in other words, the musical instrument) is restricted with respect to the location of the power transmitter. In addition, it is not possible to charge the musical instrument while the musical instrument is being played. Further, one power transmitter cannot charge a plurality of musical instruments while the plurality of musical instruments are being played simultaneously.

### SUMMARY

In view of the above circumstances, the present disclosure presents technical solutions to the above issues. An object of the present disclosure is to provide a wireless power supply system, a power receiving device and a power receiving method for charging a musical instrument, where microwaves are used for generating electric power so that a position of a power receiving device is not restricted with respect to a position of a power supply device. Another object is to provide a wireless power supply system, a power receiving device and a power receiving method for charging a musical instrument, where the musical instrument can be charged while the musical instrument is being used (i.e., in operation); and a plurality of the musical instruments can be charged while the plurality of musical instruments are in simultaneous operation. Another object is to provide a wireless power supply system, a power receiving device and a power receiving method for charging a musical instrument, where the power receiving device is attached to the musical instrument so that the power receiving device does not adversely affect the function of the musical instrument.

To achieve these objects, one aspect of the disclosure relates to a wireless power supply system for a musical instrument, wherein the system comprises: a power supply device which is configured to wirelessly transmit microwaves, and a first power receiving device which is attached to a first musical instrument, the first power receiving device being disposed away from the power supply device, wherein the first power receiving device is configured to: receive the microwaves wirelessly transmitted from the power supply device, and generate first electric power from the received microwaves, wherein the first electric power is supplied to at least one of an electronic device installed in the musical instrument and a battery installed in the musical instrument.

One aspect of the disclosure relates to a power receiving device, wherein the power receiving device comprises: a first musical instrument, and a first power receiving device attached to the first musical instrument, wherein the first power receiving device is configured to: receive wirelessly transmitted microwaves, and generate first electric power from the received microwaves, and wherein the first electric power is supplied to at least one of a first electronic device installed in the first musical instrument and a first battery installed in the first musical instrument.

One aspect of the disclosure relates to a power receiving method, wherein the power receiving method comprises: receiving wirelessly transmitted microwaves, the step being performed by a first power receiving device which is attached to a first musical instrument, and generating electric power from the received microwaves, the step being performed by the first power receiving device, wherein the first electric power is supplied to at least one of a first electronic device installed in the first musical instrument and a first battery installed in the first musical instrument.

Other objects and aspects of the disclosure will be understood by the detailed description of the invention.

### BRIEF DESCRIPTION OF THE DRAWINGS

The following drawings illustrate examples of various components of the invention disclosed herein and are for illustrative purposes only.

FIG. 1 shows a concept of power transmission using microwaves in the present disclosure.

FIG. 2 shows how electric power is supplied to the electronic device installed in the musical instrument.

FIG. 3 shows how electric power is supplied to the rechargeable battery installed in the musical instrument.

FIG. 4 shows how electric power is supplied to the electronic device and the rechargeable battery.

FIG. 5A shows one example of sending location information.

FIG. 5B shows one example of sending identification information.

FIG. 5C shows another example of sending the location information.

FIG. 6A shows one example of using a remote controller.

FIG. 6B shows another example of using a remote controller.

FIGS. 7A and 7B show one example of the musical instrument, where the musical instrument is a guitar.

FIG. 8 shows the guitar before the power receiving device is attached.

FIG. 9A shows a side view when the power receiving device is attached to the support block.

FIG. 9B shows how the power receiving device is attached to the support block when viewed from a back side.

FIG. 9C shows an enlarged side view when the power receiving device is attached to the support block.

FIG. 10 A shows a side view when the power receiving device is attached to the side board.

FIG. 10B shows how the power receiving device is attached to the side board when viewed from a back side.

FIG. 11 shows one example of timing when the power receiving device emits the signal.

### DETAILED DESCRIPTION OF THE INVENTION

### Concept of a Power Transmission

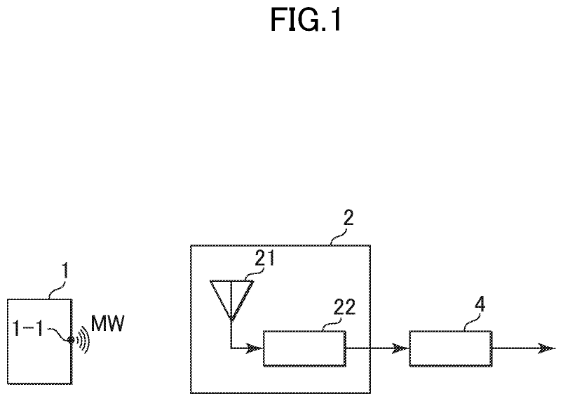

FIG. 1 shows a concept of power transmission using microwaves in the present disclosure. In FIG. 1, a power supply device 1 includes a power transmitter 1-1 which transmits microwaves MW. The power transmitter 1-1 may be an antenna. For example, a directive antenna, which transmits the microwaves towards a specific direction, may be used as the power transmitter 1-1. The directive antennal may include, for example, a parabolic antenna, a horn antenna, a slot antenna, a dielectric lens antenna and others. However, the above antennas are example, and the power transmitter 1-1 is not limited to the antenna or the above antennas. And any devices may be used as the power transmitter as long as they can transmit the microwaves MW in an intended manner. A rectifying antenna (i.e. rectenna) 2, which is attached to a musical instrument, receives the transmitted microwaves MW and converts the received microwaves MW into a direct current. The rectifying antenna 2 comprises an antenna 21, which receives the transmitted microwaves MW and converts them into a high-frequency alternating current, and a rectifier 22 which rectifies the high-frequency alternating current into a direct current. Then, the direct current is sent to a DC/DC converter 4, which converts the received direct current to predetermined DC voltage. Then, as discussed below, the direct current from the rectenna 2 is used for charging a rechargeable battery and an electronic device installed in the musical instrument.

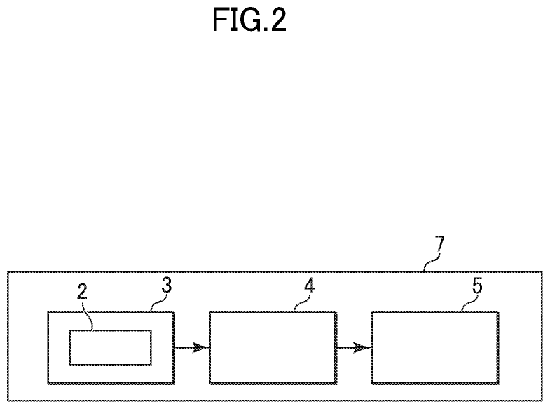

Because power is transferred by beams of electromagnetic radiation, power transmission using the microwaves MW allows a long-distance power transmission (e.g., a few meters). Thus, when a power receiving device 3 (see FIG. 2), which includes the rectifying antenna 2, is installed in the musical instrument 7, the musical installment can be located away (e.g., a few meters) from the power supply device 1. On the other hand, power transmission, which uses non-radiative techniques such as inductive charging and magnetic resonance, is normally performed within a short range (e.g., from a few centimeters to around 10 centimeters), as discussed above. Thus, by using the microwaves MW for the wireless power transmission to the musical instrument, there are more options in setting and selecting (i) timing of charging the electronic devices and the batteries (e.g., the musical instrument can be charged when the musical instrument is in operation), (ii) a number of the musical instruments to be charged by a single power supply device (e.g., a plurality of musical instruments can be charged substantially simultaneously), and (iii) locations of the musical instrument and the power supply device (i.e., a location of the musical instrument or a location of the power supply device is freely selected as long as the microwave reaches to the power receiving device installed in the musical instrument), as discussed below.

Here, in this disclosure, it is defined that the power transmission using microwaves means using radio waves with a frequency between 0.1 GHz and 10 GHz.

### Power Transmission System Used for the Musical Instrument

Charging the Musical Instrument

FIGS. 2, 3 and 4 show how electric power is distributed to a rechargeable battery 6 and to an electronic device 5, where the rechargeable battery 6 and the electronic device 5 are disposed in the musical instrument 7.

FIG. 2 shows how electric power is supplied to the electronic device 5 installed in the musical instrument 7. As discussed above, the rectifying antenna 2 generates a direct current from the received microwaves MW from the power supply device 1. Then, in FIG. 2, the direct current from a power receiving device 3, which includes the rectifying antenna 2, is sent to the DC/DC converter 4, which generates a predetermined DC voltage, as explained above. Then, the voltage from the DC/DC converter 4 is supplied to the electronic device 5. Thus, in this process, the wirelessly transmitted microwaves MW are used for directly supplying the electric power to the electronic device 5 installed in the musical instrument 7, thereby operating the electronic device 5.

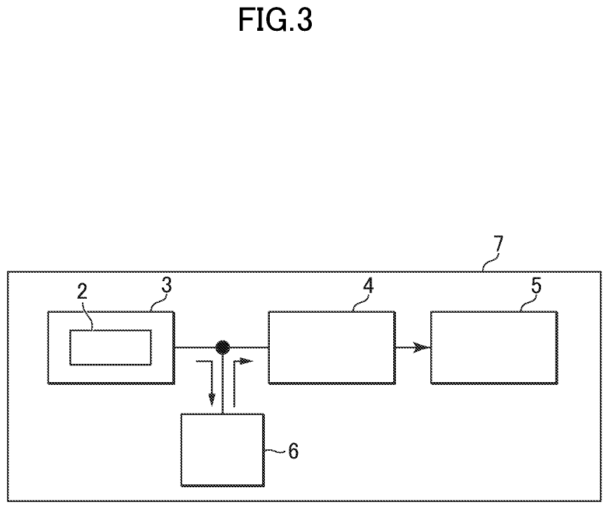

FIG. 3 shows how the electric power is supplied to the rechargeable battery 6 installed in the musical instrument 7. In FIG. 3, the direct current from the power receiving device 3, which includes the rectifying antenna 2, is sent to the rechargeable battery 6 for charging. Then, the electric power is supplied from the rechargeable battery 6 to the DC/DC converter 4. Thereafter, as discussed above, the DC/DC converter 4 generates a predetermined DC voltage and the electric power output from the DC/DC converter 4 is forwarded to the electronic device 5. Thus, in this process, the wirelessly transmitted microwaves MW are used for charging the rechargeable battery 6 which supplies the electric power to the electronic device 5.

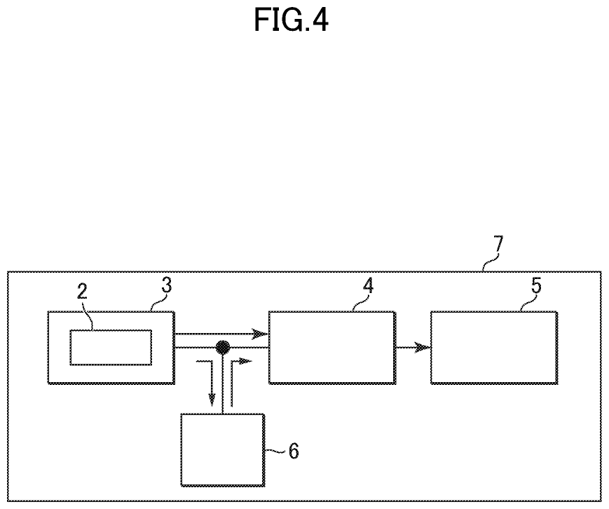

FIG. 4 shows how electric power is supplied to the electronic device 5 and the rechargeable battery 6. The power supply in FIG. 4 is a combination of the power supplies shown in FIG. 2 and FIG. 3. As shown in FIG. 4, the power from the power receiving device 3, which includes the rectifying antenna 2, is used for charging the rechargeable battery 6. Then, the electric power from the rechargeable battery 6 is sent to the DC/DC converter 4 and to the electronic device 5. At the same time, the direct current from the power receiving device 3 is directly sent to the DC/DC converter 4 and then to the electronic device 5. Thus, it is possible to charge the rechargeable battery 6, while directly supplying the electric power to the electric device 5 via the DC/DC converter 4, thereby operating the electronic device 5.

FIGS. 2, 3 and 4 show examples where one rechargeable battery 6 and one electronic device 5 are charged. However, a plurality of rechargeable batteries 6 and a plurality of electronic devices 5 can be charged simultaneously.

Examples of the Electronic Device

In FIGS. 2, 3 and 4, one example of the electronic device 5 is a preamplifier used for operating an actuator in an acoustic-electric guitar (so called an electro-acoustic guitar). Further, a transmitter of position information of the musical instrument may be charged by this charging system. For example, a global positioning transmitter of a global positioning system (GPS) may be operated by this power supply system. These examples will be discussed in detail later.

Further, the following items may also be used as the electronic devices 5 in the musical instrument 7. For example, a clock, which is installed in the musical instrument 7, may be charged by the above measures. The clock can measure how long the musical instrument 7 has been used. For example, the clock may measure the amount of time the player has played the musical instrument 7, thereby allowing the player to understand how long he or she has practiced the musical instrument 7. Further, the clock can measure the time elapsed since the musical instrument 7 was made or since the musical instrument 7 was first used, which can be used for evaluating the musical instrument. A temperature sensor which detects a temperature of the musical instrument 7 may be installed in the musical instrument 7. The measured results by the temperature sensor are used for evaluating the environment where the musical instrument 7 is maintained. A humidity sensor or a hygrometer may be installed in the musical instrument 7 for a similar purpose. Further, a pressure sensor may be installed in the musical instrument 7. For example, when the musical instrument 7 is made out of wood, for example by a wooden plate(s), the pressure sensor can measure the amount of warping the plate(s). The measured result may be used for maintaining or repairing the musical instrument 7 after comparing the measured result with its original state. An acceleration sensor may be installed in the musical instrument 7. The acceleration sensor can measure an acceleration of the musical instrument 7, thereby making it possible to recognize whether the musical instrument 7 is being played or not. This can be used for determining the timing of receiving the microwaves MW. Further, the measured result may be compared with an original acceleration value, and thus can be used for evaluating the age of the musical instrument 7. Some of these devices (e.g., the clock, the temperature sensor, and the humidity sensor) may be used with a display so that the measured results are displayed and the user (e.g., the player) of the musical instrument 7 can know the results immediately.

However, the above devices are example, and the electronic device is not limited to these devices. And any electronic devices, which are attached to the musical instrument, may be charged directly or via the rechargeable battery 6.

Sending Location Information

Further, it is possible to send location information of the musical instrument 7 to the power supply device 1. The location information identifies the musical instrument 7 which requires charging, and also provides a location of such musical instrument 7.

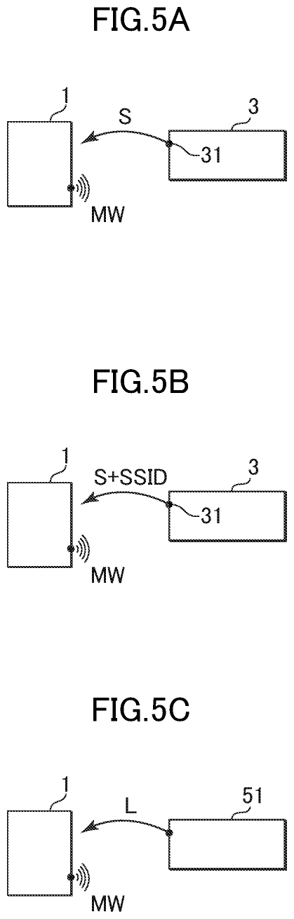

FIG. 5A shows one example of sending the location information. For example, as shown in FIG. 5A, the power receiving device 3 emits a signal S (e.g., a radio wave with a frequency of 2.4 GHz, for example) to the power supply device 1 informing that the musical instrument 7, to which the power receiving device 3 is attached, requires charging. The signal S reaches the power supply device 1 potentially from various directions, after reflection and diffraction reflecting surrounding circumstances. Then, after receiving the signal S, the power supply device 1 transmits the microwaves MW toward the direction(s) where the signal S came from. Then, the power receiving device 3 receives the microwaves MW transmitted from the power supply device 1. Radio waves such as the microwaves MW have characteristics of moving back (i.e., retrograde) a path. Thus, when the power supply device 1 transmits the microwaves MW toward any directions where the signal S came from, the microwaves MW transmitted by the power supply device 1 always reach the power receiving device 3. For example, when the signals S reaches the power supply device 1 from a few directions (in other words, a few paths), the power supply device 1 may transmit the microwaves MW toward a direction where the signal S reaches the power supply device 1 first. A path where the first signal S reaches the power supply device 1 is likely to be a shortest path between the power supply device 1 and the power receiving device 3. Transmitting the microwaves MW toward the direction where the first signal S came from is one example, and the power supply device 1 may transmit the microwaves MW any directions as long as the microwaves MW reach the power receiving device 3.

Here, the radio wave with a frequency of 2.4 GHz is one example of the signal S, and the signal S is not limited to this frequency, and radio waves with other frequencies may be used as the signal S as long as they perform the intended purpose of this disclosure. The power receiving device 3 may include a signal transmitter 31 which emits the signal S. The signal transmitter 31 may be an antenna that is different from the antenna 21 that receives the microwaves MW. However, it is not necessary that the signal transmitter 31 is the antenna, and any apparatus may be used as the signal transmitter 31 as long as it performs the intended purpose. Further, a bidirectional antenna may be used so that the bidirectional antenna serves as both the antenna 21 which receives the microwaves MW and the signal transmitter 31 which emits the signal S.

The power receiving device 3 may automatically emit the signal S when the electronic device 5 is turned on, when the musical instrument 7 is turned on, or when the player starts playing the musical instrument 7. Further, the signal S may be sent when a charged level of the rechargeable battery 6 falls to a predetermined level. Alternatively, a starting switch may be installed in the power receiving device 3 or the musical instrument 7 so that the signal S is sent when the switch is turned on by a player or an operator other than the player. Further, the signal transmitter 31 may always emit the signal S at a predetermined time interval. For example, when the above discussed clock and the acceleration sensor are installed in the musical instrument 7, the signal S may be always emitted at a predetermined time interval so that these devices are regularly operated. The timing of when to emit the signal S will be further discussed later, when discussing the musical instrument 5 being a guitar.

The signal S serves as the identification means which identifies the musical instrument 7 which requires charging, as well as serves as the location information of such musical instrument 7. Further, sending the signal S from the power receiving device 3 also identifies the timing when the musical instrument 7 needs to be charged.

Further, the power supply device 1 may send a signal (e.g., a radio wave with a frequency of 2.4 GHz, for example) to the power receiving device 3. In this case, the signal from the power supply device 1 serves as location information of the power supply device 1, thereby the power receiving device 3 can emits the signal S in accordance with the location information indicated by the signal from the power supply device 1. The power transmitter 1-1 or a signal transmitter, which is different from the power transmitter 1-1, may be used for sending the signal from the power supply device 1.

Authentication Measure

The system may include an authentication measure. For example, a Service Set Identifier (SSID) may be used for the authentication. FIG. 5B shows one example of sending the identification information. The power supply device 1 stores a list of SSIDs which identify the power receiving devices 3 (which means the musical instruments 7) to which the microwaves MW are to be sent. The power receiving device 3 sends the signal S together with its SSID to the power supply device 1, and then the power supply device 1 checks whether the received SSID is a previously stored SSID. Then, when the received SSID corresponds to the previously stored SSID, the power supply device 1 sends the microwaves MW to the power receiving device 3 which sent the signal S and the SSID. Alternatively, a password may be used for authentication instead of the SSID. Similar to the above process, the power receiving device 3 sends the signal S together with its password. Then, the power supply device 1 sends the microwaves MW to the power receiving device 3 which sent the signal S and the password only when the received password corresponds to a previously stored password which indicates the musical instrument 7 to which the microwaves MW are to be sent. The power receiving device 3 may send the SSID and the password separately from the signal S, or the SSID and the password may be included in the signal S.

Including the authentication measure ensures that only the intended musical instrument is charged. This is specifically advantageous when it is intended to charge only one musical instrument or a limited number of musical instruments among a plurality of musical instruments which are located close to each other.

A Global Positioning System

A global positioning system (GPS) may be used for transmitting location information of the musical instrument. FIG. 5C shows another example of sending the location information. In FIG. 5C, a GPS receiver and radio transmitter (transceiver) 51 is attached to the musical instrument 7. The GPS transceiver 51, which is one example of an electronic device 5, receives radio waves and signals from GPS satellites (not shown) and calculates location information L of the musical instrument 7. Then, the GPS transceiver 51 transmits the location information L of the musical instrument 7 to the power supply device 1. After receiving the location information L, the power supply device 1 transmits the microwaves MW to the musical instrument 7 in accordance with the location information L of the musical instrument 7.

In this example, the location information L of the musical instrument 7 can also be used in locating the musical instrument 7 when the musical instrument 7 is missing. Further, when the GPS transceiver 51 is directly charged from the power receiving device 3, the GPS transceiver 51 may be included in the power receiving device 3 instead of being attached to the musical instrument 7. The GPS transceiver 51 may also always emit the location information L at a predetermined time interval so that the location of the musical instrument 7 can be regularly monitored. A radio wave with a frequency of 4 GHz, for example, may be used for sending the location information L. Further, it is not limited to this frequency, and radio waves with other frequencies may be used as long as they perform the intended purpose of this disclosure.

Further, the GPS may be used for transmitting location information of the power supply device 1 to the power receiving device 3 so that the power receiving device 3 emits the signal S in accordance with the location information of the power supply device 1. In this example, the power supply device 1 may include a GPS transceiver, which receives radio waves and signals from the GPS satellites, calculates location information of the power supply device 1, and sends the location information of the power supply device 1 to the power receiving device 3.

Remote Control

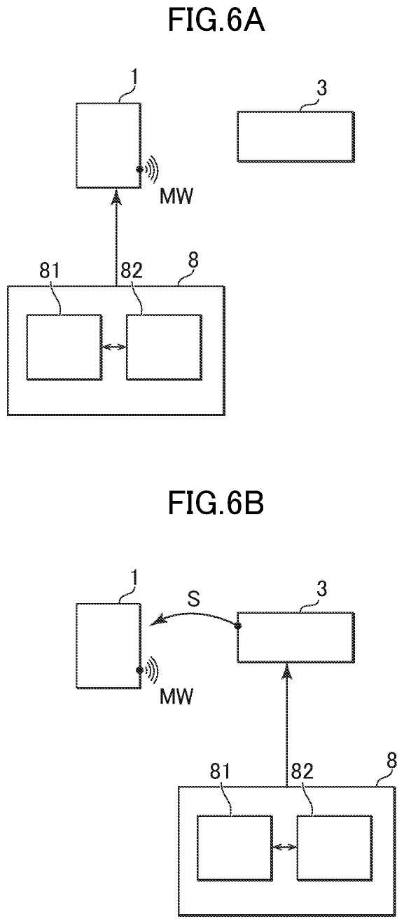

A remote controller such as a computer system, a portable computing device, a cellular phone, a smartphone etc., may be used together with the above measures. FIG. 6A shows one example of using the remote controller, and FIG. 6B shows another example of using the remote controller. The remote controller 8 includes a control unit 81 such as CPU, a processor or a microcomputer, and a memory 82 such as ROM and RAM and others. The memory 82 stores an application and when the application is executed by the control unit 81, the application enables the remote controller 8 to wirelessly communicate with the power supply device 1, and provide instructions to the power supply device 1 such as instructing the power supply device 1 to send microwaves MW to the specific power receiving device 3 (see FIG. 6A). The remote controller 8 may receive the location information L of the musical instrument 7 from the GPS transceiver 51 and transmit the location information L of the musical instrument 7 to the power supply device 1 together with the instruction to send the microwaves MW to the power receiving device 3. Thus, the microwaves MW are sent to the intended power receiving device 3. Alternatively, the application may enable the remote controller 8 to provide the instructions to the power receiving device 3 so that the power receiving device 3 sends the signal S to the power supply device 1 (see FIG. 6B). After receiving the signal S, the power supply device 1 transmits the microwaves MW to the power receiving device 3. The remote controller 8 may be operated by the player of the musical instrument 7 or a person other than the player of the musical instrument 7. The remote controller 8 can also communicate to the power supply device 1 and the power receiving device 3 through wired communication.

### Guitar as One Example of the Musical Instrument

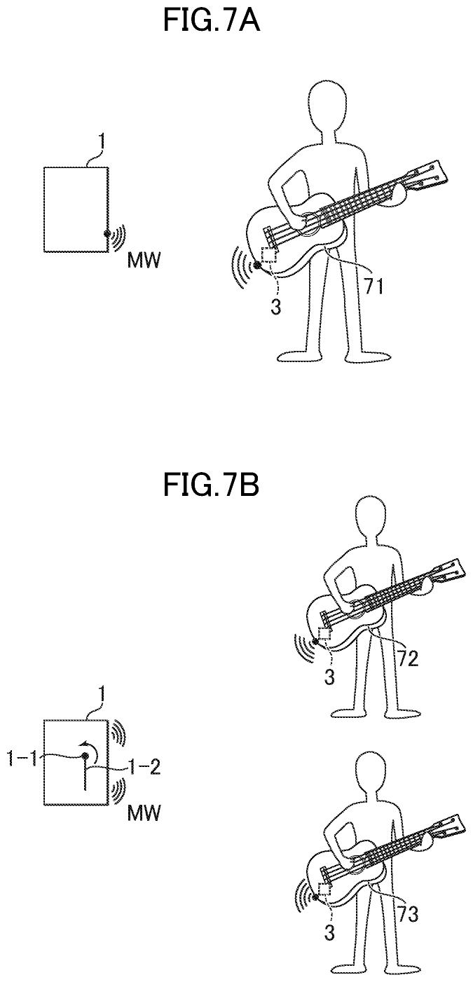

FIGS. 7A and 7B show one example of the musical instrument, where the musical instrument is a guitar. The guitar may be an acoustic-electric guitar, for example. FIG. 7A shows that a guitar 71 is being played by a player. The power receiving device 3 is attached to the guitar 71. The power supply device 1 is disposed around the guitar 71. For example, the power supply device 1 may be disposed a few meters away from the power receiving device 3. The power supply device 1 may be disposed on a back side or on a front side of the guitar 71. The location of the power supply device 1 is not limited to these positions. The power supply device 1 can be disposed anywhere as long as the microwaves MW reach the power receiving device 3. As shown FIG. 7A, because the power receiving device 3 can be disposed a few meters away from the power supply device 1, the guitar 71 can be wirelessly charged while the player is playing the guitar 71.

FIG. 7B shows that two guitars 72, 73 are played by respective players. The power supply device 1 transmits the microwaves MW to each of the power receiving devices 3 and 3 of guitars 72 and 73. For example, the power transmitter 1-1 of the power supply device 1 changes a direction of a beam of the microwaves MW by rotating the power transmitter 1-1 around a rotation axis 1-2 while transmitting the microwaves MW in accordance with incoming directions of two signals S emitted from two power receiving devices 3, 3. Then, two power receiving devices 3, 3 receive the transmitted microwaves MW from the power supply device 1 alternatively and consecutively (i.e., substantially simultaneously). Alternatively, a rotating angle of the power transmitter 1-1 may be selected from among a plurality of rotating angles (e.g., 15°, 30°, 45°, 90° and 135°). Any mechanism to set the rotation angle of the power transmitter 1-1 may be used as long as they perform intended purpose of this disclosure. It is also possible to rotate the power supply device 1 instead of rotating the power transmitter 1-1 so that the microwaves MW are sent to two power receiving devices 3, 3, or a rotating angle of the power supply device 1 is selected from among the plurality of plurality of angles. It is also possible to use a solid state power transmitter 1-1, in which the direction of transmission is controlled electrically and not mechanically.

In addition, when the remote controller 8 is used to control the transmission of the microwaves MW, the application in the memory 82 may enable the remote controller 8 to instruct the power transmitter 1-1 so that power transmitter 1-1 transmits the microwaves MW while rotating a specified rotating angle. The application may be also designed to enable the remote controller 8 to select the rotating angle of the power transmitter 1-1 from among a plurality of rotating angles (e.g., 15°, 30°, 45°, 90° and 135°). Thus, it is possible to charge two guitars 72, 73 by one power transmitter-1 1 while two guitars 72 and 73 are being played simultaneously. In addition, two guitars 72 and 73 can be charged alternatively and successively (in other words, substantially simultaneously) while the power transmitter 1-1 continuously transmits the microwaves MW.

In FIGS. 7A and 7B, after the power receiving device 3 wirelessly receives the microwaves MW from the power supply device 1, the received microwaves MW are converted to direct current and used for charging the electronic device 5 and the rechargeable battery 6 installed in the guitars 71, 72, and 73, as discussed above.

Further, in FIGS. 7A and 7B, each guitar may be charged while it is not being played. In addition, in FIG. 7B, one guitar 72 may be charged while it is being played and another guitar 73 may be charged when it is not being played. Further, charging two guitars 72 and 73 is one example. It is not limited to charge two guitars and three or more guitars can be charged in the similar manner. In addition, it is possible to charge one or more guitars and other musical instruments such as an electronic guitar, a violin(s), a cello(s), a viola(s), a mandolin(s), a tuner(s), a metronome(s), etc., in a similar manner.

### Examples of Installing the Power Receiving Device to the Guitar

Next, examples of installing the power receiving device 3 to the guitar 71 will be explained.

Guitar Before Installing the Power Receiving Device

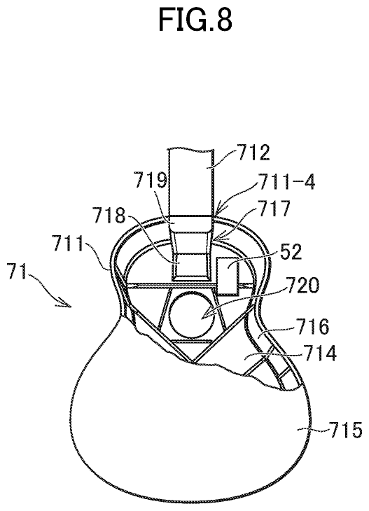

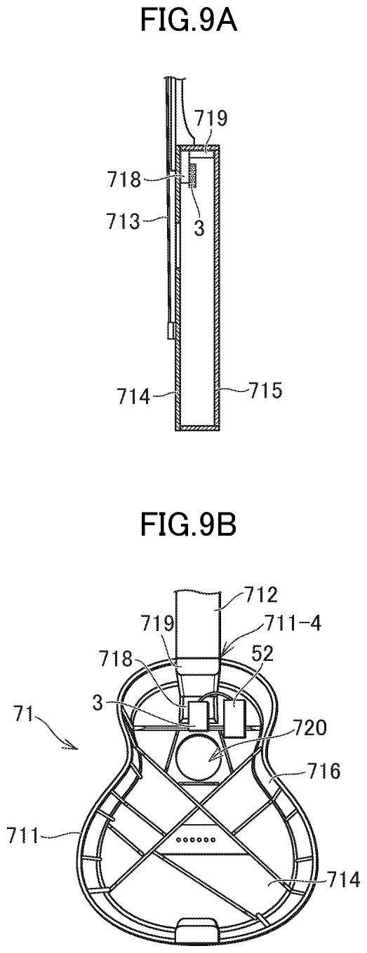

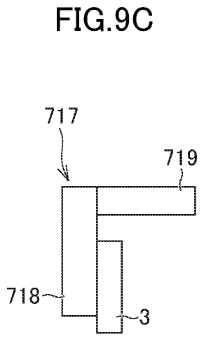

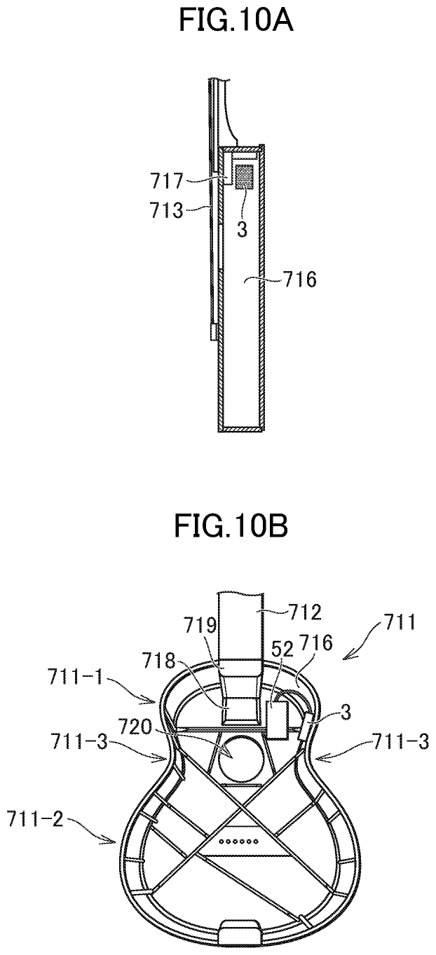

FIG. 8 shows the guitar 71 before the power receiving device 3 is attached. In FIG. 8, the guitar 71 comprises a body 711 and a neck 712 which is connected to the body 711, and strings 713 (See FIGS. 9A and 10A) are extended between one end portion of the neck 712 and the body 711. The body 711 includes a front board 714, a back board 715, which has a similar shape with the front board 714 and extends substantially in parallel with the front board 714, and a side board 716, which is formed along a peripheral portion of the body 711. The side board 716 connects a peripheral portion of the front board 714 and a peripheral portion of the back board 715. Thus, the body 711 forms a hollow box. A substantially L-shaped support block 717 is disposed in the body 711 at an upper end portion 711-4 of the body 711. In this disclosure, it is defined that an end potion connected to the neck 712 is the upper end portion 711-4 of the body 711. The support block 717 has a first member 718 and a second member 719 which extends substantially perpendicular to the first member 718. An outer surface of the first member 718 is attached to the front board 714 and an outer surface of the second member 719 is attached to the side board 716, by an adhesive, a bolt or other measures. The support block 717 serves as a reinforcement member of the hollow shaped body 711 so that the support block 717 maintains a structural strength (i.e., a rigidity) of the hollow-shaped body 711 and resists the tension of the strings 713 and suppresses vibration of the body 711.

A preamplifier 52 is attached to the body 711 and is used for operating an actuator (nor shown). The preamplifier 52 amplifies electrical signals which are converted from vibrations of the strings by a pickup (not shown), and outputs the amplified electrical signals to the actuator. The actuator vibrates the back board 715 in accordance with a strength of the amplified electrical signal output from the preamplifier 52, thereby enhancing an acoustic effect. A sound generated inside the body 711 is emitted from a sound hole 720 formed in the front board 714 while vibrating the front board 714. The preamplifier 52 is one example of the electronic device 5 in this disclosure.

Installing the Power Receiving Device to the Guitar

In this disclosure, the power receiving device 3 is attached to a part of the body 711 so that the power receiving device 3 does not adversely affect a vibration of the guitar 71.

FIGS. 9A. 9B and 9C show one example of attaching the power receiving device 3 to the guitar. FIG. 9A shows a side view when the power receiving device 3 is attached to the support block 717, where the preamplifier 52 is omitted; FIG. 9B shows how the power receiving device 3 is attached to the support block 717 when viewed from a back side, where the back board 715 is omitted; and FIG. 9C shows an enlarged side view when the power receiving device 3 is attached to the support block 717. The power receiving device 3 is attached to an inner surface of the first member 718 of the support block 717 by an adhesive, a double-sided tape, a screw, or a bolt, for example. The power receiving device 3 is electrically connected to the preamplifier 52, which is attached to the body 711, and provides the electric power to the preamplifier 52. As discussed above, the support block 717 is disposed at the upper end portion 711-4 of the body 711 and is the reinforcement member which suppresses vibration. Thus, an area of the front board 714 where the support block 717 is attached becomes a node of the vibration of the front board 714. Thus, the support block 717 is unlikely to vibrate. Accordingly, because the power receiving device 3 is attached to the support block 717, the power receiving device 3 is unlikely to vibrate and thus does not adversely affect the vibration of the guitar 71. The shape of the support block 717 is not limited to the substantially L-shape, and any shapes may be available as long as they perform the intended function of this disclosure. In addition, the power receiving device 3 may be attached to any portion of the support block 717 including, but not limited to, an inner surface of the second member 719. In addition, the support block 717 may be attached to the back board 715 and the side board 716.

FIGS. 10A and 10B show another example of attaching the power receiving device 3. FIG. 10 A shows a side view when the power receiving device 3 is attached to the side board 716, where the preamplifier 52 is omitted; and FIG. 10B shows how the power receiving device 3 is attached to the side board 716 when viewed from a back side, where the back board 715 is omitted. In this disclosure, it is defined that a side outside of the front board 714 is a front side, and a side outside of the back board 715 is the back side.

As shown in FIG. 10B, the body 711 of the guitar 71 has a shape like a gourd such that there are an upper portion 711-1 and a lower portion 711-2 separated by a constriction 711-3. The upper portion 711-1 has a smaller area than the lower portion 711-2. The power receiving device 3 is attached to an inner surface of the side board 716, which is located in the upper portion 711-1 of the body (in other words, above the constriction 711-3), by an adhesive, a double-sided tape, a screw, or a bolt, for example. As discussed above, the front board 714 and the back board 715 vibrate while the guitar 71 is being played. On the other hand, the side board 716 is unlikely to vibrate compared with the front board 714 and the back board 716, when the guitar 71 is being played. Further, because the upper portion 711-1 has the smaller area than the lower portion 711-2, the upper portion 711-1 has less effect on the vibration than the lower portion 711-2. Thus, by attaching the power receiving device 3 to the side board 716 in the upper portion 711-1 (i.e., between the constriction 711-3 and the upper end portion 711-4) of the side board 716, the power receiving device 3 does not adversely affect the vibration of the guitar 71 (i.e., the function of the guitar 71).

In view of the function of the guitar 71, controlling the vibration of the body 711 is essential to the guitar 71. In this regard, it is advantageous to attach the power receiving device 3 to the area of the body 711 where the power receiving device 3 does not adversely affect the vibration (i.e., the function) of the guitar 71. Further, attaching the power receiving device 3 does not require any modification or change to the existing guitar 71.

In the above examples, the power receiving device 3 is directly attached to the first member 718 and the side board 716. Alternatively, the power receiving device 3 may be attached to the first member 718 and the side board 716 via a base plate which is attached to a bottom surface of the power receiving device 3. Further, the above examples of attaching the power receiving device 3 also apply to the guitar 72 and 73 and other similarly shaped instruments.

Timing of Emitting the Signal

Next, timing of emitting the signal S and the microwaves MW will be explained when the power receiving device 3 is attached to the guitar 71.

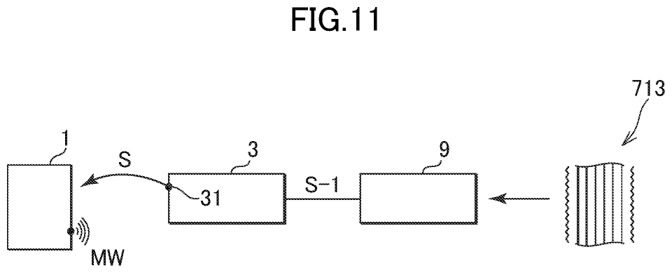

FIG. 11 shows one example of timing when the power receiving device 3 emits the signal S. The power receiving device 3 may emit the signal S when strings 713 of the guitar 71 start vibrating (in other words, when a player starts playing guitar 71). For example, as discussed above, in the acoustic-electric guitar, the pickup detects the vibration of the strings 713. Thus, as shown in FIG. 11, the pickup 9 may send a signal S-1 to the power receiving device 3 when the pickup 9 detects the vibration of the strings 713. Then, after receiving the signal S-1 from the pickup 9, the power receiving device 3 emits the signal S to the power supply device 1 requesting the microwave MW.

Alternatively, the acceleration sensor, which is one example of the electronic device 5 as discussed above, may be used for detecting the start of playing the guitar 71. It can be determined that the player starts playing the guitar 71 when the acceleration sensor detects the acceleration of the guitar 71. Then, similar to the pickup 9, the acceleration sensor sends a signal to the power receiving device 3. Then, after receiving the signal from the acceleration sensor, the power receiving device 3 emits the signal S to the power supply device 1 requesting transmission of the microwaves MW. Alternatively, the power receiving device 3 may emit the signal S when it does not receive the signal from the acceleration sensor, which means that the microwaves MW are transmitted from the power supply device 1 when the guitar 71 is not being played. The acceleration sensor is attached to the guitar 71 in addition to the preamplifier 52.

In addition, the remote controller 8 may be used together with the guitar 71. That is, the remote controller 8 may instruct the power receiving device 3 to emit the signal S, or the power supply device 1 to transmit the microwaves MW, as discussed above.

### Advantages

In the present disclosure, power is transferred by beams of microwaves, and thus, the power transmission using the microwaves enables longer-distance power transmission (e.g., a few meters), while power transmission using non-radiative techniques such as the inductive charging and the magnetic resonance is normally performed within a short rage (e.g., from a few centimeters to around 10 centimeters). Thus, the power receiving device 3 and the musical instrument 7 can be located away (e.g., a few meters) from the power supply device 1. Thus, it is possible to charge the musical instrument 7, while the musical instrument 7 is in operation. In addition, a plurality of musical instruments 7 can be charged by one power supply device 1, while the plurality of musical instruments 7 are in operation simultaneously. Further, it is also possible to dispose the power supply device 1 (or the power receiving device 3) at any location as long as the transmitted microwaves MW reach the power receiving device 3. Thus, by using the microwaves MW for the wireless power transmission, there are more options in selecting a number of the musical instruments 7 to be charged, the locations of the musical instrument(s) 7 and the power supply device 1, and timing of charging.

Further, the power receiving device 3 is attached to the support block 717 disposed adjacent to the upper end portion of the body 711 or the side board 716 which is located in the upper portion 711-1 of the body 711. Thus, the power receiving device 3 does not adversely affect the vibration (i.e., the function) of the guitar. Further, attaching the power receiving device 3 does not require any modification or change to the guitar.

Further, other advantages will be understood by the above detailed description of the present disclosure.

Here, the acoustic guitar is used as one example of the musical instrument. However, the musical instrument is not limited to the acoustic guitar. Other musical instruments such as an electronic guitar, a banjo, a double bass, a mandolin, an ukulele, a violin, a viola, a cello, an acrostic cymbal, an electronic cymbal, and others may be used as the music instrument as long as the power can be wirelessly transmitted using microwaves.

Further, in this disclosure, the musical instruments are not limited to the above instruments which are played by a player. Instead, the musical instruments include other type of instruments which are not played by the player, but perform functions related to sound or music. These instruments include, but not limited to, a tuner, a metronome, a wireless microphone, a wireless speaker, and a mute.

While specific embodiments of the invention have been shown and described in detail to illustrate the application of the principles of the invention, it is understood that the invention may be embodied otherwise without departing from such principles. It is further understood that the invention is not limited to the specific embodiments and examples described herein, but is defined by the appended claims.

1. A wireless power supply system for a musical instrument, comprising:
a power supply device which is configured to wirelessly transmit microwaves using a directive antenna, and
a first power receiving device which is attached to a first musical instrument, the first power receiving device being disposed away from the power supply device, the first power receiving device is configured to:
receive the microwaves wirelessly transmitted from the power supply device, and
generate first electric power from the received microwaves, the first electric power being supplied to at least one of a first electronic device installed in the first musical instrument and a first battery installed in the first musical instrument, wherein
the first power receiving device is configured to emit a signal to the power supply device, and
the power supply device wirelessly transmits the microwaves to the first power receiving device when the Dower supply device receives the signal from the first power receiving device.

2. The system according to claim 1, wherein the first power receiving device receives the wirelessly transmitted microwaves and generates the first electric power, while the first musical instrument is in operation.

3. The system according to claim 1, wherein the first power receiving device supplies the first electric power to the first electronic device and to the first battery, simultaneously.

4. (canceled)

5. The system according to claim 1, further comprising:
a controller comprising,
a memory that stores instructions, and
a controller that executes the instructions stored in the memory to:
(i) instruct the power supply device to transmit the microwaves to the first power receiving device, or
(ii) instruct the first power receiving device to emit the signal to the power supply device.

6. The system according to claim 1, further comprising:
a second power receiving device attached to a second musical instrument which is different from the first musical instrument, the second power receiving device being different from the first receiving device and being disposed away from the power supply device, the second power receiving device is configured to:
receive the microwaves wirelessly transmitted from the power supply device, and
generate second electric power from the received microwaves, the second electric power being different from the first electric power, the second electric power being supplied to at least one of a second electronic device installed in the second musical instrument and a second battery installed in the second musical instrument.

7. The system according to claim 1, wherein
the first musical instrument has a hollow-shaped body and a neck, and
the first power receiving device is attached to a support block which maintains a structural rigidity of the hollow-shaped body, the support block being disposed in the body adjacent to an upper end portion of the body.

8. The system according to claim 7, wherein
the support block has a first member and a second member which extends substantially perpendicular to the first member, and
the first power receiving device is attached to one of the first member and the second member.

9. The system according to claim 1, wherein
the first musical instrument has a body and a neck,
the body has a front board, a back board which extends substantially in parallel with the front board, and a side board which connects the front board and the back board,
the body has an upper portion and a lower portion which has a larger area than the upper portion when viewed from a front side of the first musical instrument, the upper portion and the lower portion being separated by a constriction, and
the first power receiving device is attached to the side board located in the upper portion of the body.

10. A power receiving device, comprising:
a musical instrument, and
a first power receiving device attached to the first musical instrument, the first power receiving device is configured to:
emit a signal,
receive wirelessly transmitted microwaves, and
generate first electric power from the received microwaves, the first electric power being supplied to at least one of a first electronic device installed in the first musical instrument and a first battery installed in the first musical instrument,
wherein the first power receiving device is configured to emit the signal before receiving the wirelessly transmitted microwaves, and the signal is used for requesting the microwaves to be wirelessly transmitted.

11. The power receiving device according to claim 10, wherein the first power receiving device receives the wirelessly transmitted microwaves and generates the first electric power, when the first musical instrument is in operation.

12. The power receiving device according to claim 10, wherein the first power receiving device supplies the first electric power to the first electronic device and to the first battery, simultaneously.

13. The power receiving device according to claim 10, further comprising:
a second musical instrument which is different from the first musical instrument, and
a second power receiving device attached to the second musical instrument, the second power receiving device being different from the first power receiving device, the second power receiving device is configured to:
receive the wirelessly transmitted microwaves, and
generate second electric power from the received microwaves, the second electric power being different from the first electric power, the second electric power being supplied to at least one of a second electronic device installed in the second musical instrument and a second battery installed in the second musical instrument.

14. The power receiving device according to claim 10, wherein
the first musical instrument has a hollow-shaped body and a neck, and
the first power receiving device is attached to a support block which maintains a structural rigidity of the hollow-shaped body, the support block being disposed in the body adjacent to an upper end portion of the body.

15. The power receiving device according to claim 14, wherein
the support block has a first member and a second member which extends substantially perpendicular to the first member, and
the power receiving device is attached to one of the first member and the second member.

16. The power receiving device according to claim 10, wherein
the first musical instrument has a body and a neck,
the body has a front board, a back board which extends substantially in parallel with the front board, and a side board which connects the front board and the back board, and
the first power receiving device is attached to the side board.

17. The power receiving device according to claim 16, wherein
the body has an upper portion and a lower portion which has a larger area than the upper portion when viewed from a front side of the first musical instrument, the upper portion and the lower portion being separated by a constriction, and
the first power receiving device is attached to the side board located in the upper portion of the body.

18. A power receiving method, comprising:
emitting a signal, the step being performed by a first power receiving device which is attached to a first musical instrument,
receiving wirelessly transmitted microwaves, the step being performed by the first power receiving device, and
generating first electric power from the received microwaves, the first electric power being supplied to at least one of a first electronic device installed in the first musical instrument and a first battery installed in the first musical instrument, the step being performed by the first power receiving device,
wherein the step of emitting the signal is performed before the step of receiving the wirelessly transmitted microwaves, and the signal is used for requesting the microwaves to be wirelessly transmitted.

19. The power receiving method according to claim 18, wherein the step of receiving the wirelessly transmitted microwaves and the step of generating the first electric power are performed when the first musical instrument is in operation.

20. The power receiving method according to claim 18, further comprising:
receiving wirelessly transmitted microwaves, the step being performed by a second power receiving device attached to a second musical instrument, the second musical instrument being different from the first musical instrument, the second power receiving device being different from the first power receiving device, and
generating second electric power from the received microwaves, the second electric power being supplied to at least one of a second electronic device installed in the second musical instrument and a second battery installed in the second musical instrument, the step being performed by the second power receiving device.
